(19) United States
(12) Patent Application Publication
(10) Pub. No.: US 2026/0006287 A1
(43) Pub. Date: Jan. 1, 2026

(54) LINKING DEVICES TO ENHANCE USER EXPERIENCE

(71) Applicant: Sony Group Corporation, Tokyo (JP)

(72) Inventors: James R. Milne, Ramona, CA (US); Justin Kenefick, San Diego, CA (US); William Clay, San Diego, CA (US); Marvin DeMerchant, San Diego, CA (US)

(73) Assignee: Sony Group Corporation, Tokyo (JP)

(21) Appl. No.: 18/759,592

(22) Filed: Jun. 28, 2024

(51) Int. Cl. H04N 21/436; H04N 21/45

(52) U.S. Cl. CPC H04N 21/436; H04N 21/4518

(57) ABSTRACT

Implementations generally relate to the linking of smart devices to enhance user experience. In some implementations, a method includes detecting, by a first media device, a presence of a second media device, where the first media device includes a primary artificial intelligence (AI) module. The method further includes establishing communication between the first media device and the second media device. The method further includes determining configuration information associated with the second media device. The method further includes sharing functionality of the primary AI module with the second media device based on the configuration information.

### BACKGROUND

Artificial intelligence (AI) can be a costly resource when implemented in lower-priced consumer electronics. Accordingly, it might not make economic sense and cost prohibitive to implement AI into every consumer device. Conventional solutions may employ a centralized architecture having AI capabilities that may be used with electronic devices.

### SUMMARY

Implementations generally relate to linking smart devices to enhance user experience. In some implementations, a system includes one or more processors, and includes logic encoded in one or more non-transitory computer-readable storage media for execution by the one or more processors. When executed, the logic is operable to cause the one or more processors to perform operations including: detecting, by a first media device, a presence of a second media device, where the first media device includes a primary artificial intelligence (AI) module; establishing communication between the first media device and the second media device; determining configuration information associated with the second media device; and sharing functionality of the primary AI module with the second media device based on the configuration information.

With further regard to the system, in some implementations, the configuration information includes function information associated with the second media device. In some implementations, the logic when executed is further operable to cause the one or more processors to perform operations including: accessing one or more functions of the second media device; and enhancing the one or more functions of the second media device using the primary AI module of the first media device. In some implementations, the configuration information includes input/output port information associated with the second media device. In some implementations, the logic when executed is further operable to cause the one or more processors to perform operations including: accessing one or more input/output ports of the second media device; and enhancing operability of the one or more input/output ports of the second media device using the primary AI module of the first media device. In some implementations, the configuration information includes setup information associated with the second media device. In some implementations, the logic when executed is further operable to cause the one or more processors to perform operations including: accessing the configuration information associated with the second media device; and configuring the second media device using the primary AI module of the first media device.

In some implementations, a non-transitory computer-readable storage medium with program instructions thereon is provided. When executed by one or more processors, the instructions are operable to cause the one or more processors to perform operations including: detecting, by a first media device, a presence of a second media device, where the first media device includes a primary AI module; establishing communication between the first media device and the second media device; determining configuration information associated with the second media device; and sharing functionality of the primary AI module with the second media device based on the configuration information.

With further regard to the computer-readable storage medium, in some implementations, the configuration information includes function information associated with the second media device. In some implementations, the instructions when executed are further operable to cause the one or more processors to perform operations including: accessing one or more functions of the second media device; and enhancing the one or more functions of the second media device using the primary AI module of the first media device. In some implementations, the configuration information includes input/output port information associated with the second media device. In some implementations, the instructions when executed are further operable to cause the one or more processors to perform operations including: accessing one or more input/output ports of the second media device; and enhancing operability of the one or more input/output ports of the second media device using the primary AI module of the first media device. In some implementations, the configuration information includes setup information associated with the second media device. In some implementations, the instructions when executed are further operable to cause the one or more processors to perform operations including: accessing the configuration information associated with the second media device; and configuring the second media device using the primary AI module of the first media device.

In some implementations, a method includes: detecting, by a first media device, a presence of a second media device, where the first media device includes a primary AI module; establishing communication between the first media device and the second media device; determining configuration information associated with the second media device; and sharing functionality of the primary AI module with the second media device based on the configuration information.

With further regard to the method, in some implementations, the configuration information includes function information associated with the second media device. In some implementations, the method further includes: accessing one or more functions of the second media device; and enhancing the one or more functions of the second media device using the primary AI module of the first media device. In some implementations, the configuration information includes input/output port information associated with the second media device. In some implementations, the method further includes: accessing one or more input/output ports of the second media device; and enhancing operability of the one or more input/output ports of the second media device using the primary AI module of the first media device. In some implementations, the configuration information includes setup information associated with the second media device.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for some implementations described herein.

FIG. 2 is an example flow diagram for linking devices to enhance user experience, according to some implementations.

FIG. 3 illustrates a block diagram of an example network environment, which may be used for some implementations described herein.

FIG. 4 illustrates a block diagram of an example computing system, which may be used for some implementations described herein.

### DETAILED DESCRIPTION

Implementations described herein enable, facilitate, and manage the linking of smart devices to enhance user experience. As indicated herein, artificial intelligence (AI) can be a costly resource when implemented in lower-priced consumer electronics, making it less economically optimal to implement AI into many consumer devices. Embodiments described herein link electronic devices together and pool their resources to produce a more synergistic outcome, thereby enhancing user experience. In various embodiments, different electronic or smart devices may utilize different AI technologies. Embodiments described herein link different smart devices and also link their respective AI technologies to work in concert to enhance user experience.

As described in more detail herein, in various implementations, a system detects, via a first media device, a presence of a second media device. As described in more detail herein, the first media device includes a primary AI module. The system establishes communication between the first media device and the second media device. The system further determines configuration information associated with the second media device. The system shares functionality of the primary AI module with the second media device based on the configuration information.

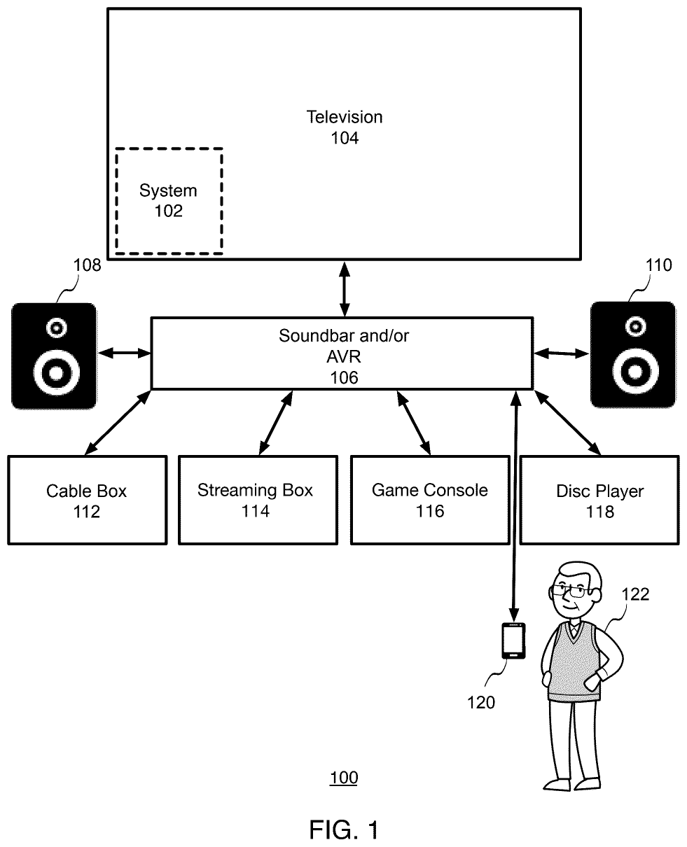

FIG. 1 illustrates a block diagram of an example media environment 100, which may be used for some implementations described herein. In some implementations, media environment 100 includes a system 102, a television 104, a soundbar and/or audio-video receiver (AVR) 106, speakers 108 and 110, a cable box 112, a streaming box 114, a game console 116, a disc player 118, and a smartphone 120. In various implementations, smartphone 102 may function as a remote-control device for any one or more of television 104, soundbar and/or AVR 106, speakers 108 and 110, cable box 112, streaming box 114, game console 116, disc player 118, and/or other media devices. Also shown is a user 122.

In various implementations, soundbar and/or audio-video receiver (AVR) 106 may also be referred to as media component 106. Media component 106 may be a soundbar, an AVR, or combination thereof. In some implementations, when a soundbar is used, sources may be routed via television 104, thereby making media environment 100 a video centric system. In some implementations, when an AVR is used, sources may be routed via the AVR, thereby making media environment 100 an audio centric system. In various implementations, when both a soundbar and an AVR are used, system 102 may configure media environment 100 to be video centric and/or audio centric. In various implementations, the primary AI module of system 102 is aware of the capabilities of media component 106. In some implementations, system 102 may query the user to further optimize media environment 100, especially if the user upgrades from one to the other.

While system 102 is shown to be integrated with and reside within television 102, system 102 may be positioned anywhere in media environment 100. For example, in some implementations, system 102 may be integrated with soundbar and/or AVR 106. In some implementations, system 102 may be integrated with smartphone 120. In some implementations, system 102 may reside in a stand-alone unit. In some implementations, system 102 may be located in remote locations (e.g., in the cloud). The particular location of system 102 may vary and will depend on the particular implementation.

As described in more detail herein, in various implementations, system 102 establishes communication among the media devices in media environment 100. System 102 further determines configuration information associated with the various media devices. System 102 shares functionality of a primary AI module associated with system 102 with one or more other media devices based on respective configuration information. Various example implementations directed to the sharing of functionality of the primary AI module are described in detail herein.

In various implementations, the AI module of system 102 is referred to as a primary AI module, because the primary AI module facilitates system 102 in the linking of the various second media devices together, as well as the sharing of various resources (e.g., AI resources, I/O ports, etc.) as described herein.

Some of the second media devices may have their own intelligence built in (e.g., their own AI modules). Some of the second media drives might not have intelligence built in. As described in more detail herein, the primary AI module enables the sharing resources including AI resources among devices with or without their own intelligence. This is beneficial in that such sharing or resources effectively upgrades second media devices with new capabilities in a cost-effective manner. The primary AI module may also be referred to as a master AI module and another other AI modules of second media devices may be referred to as slave AI modules.

In various implementations, system 102 enhances the experience of user 122 with regard to any combination of the components of media environment 100 and in different scenarios. For example, as describe more detail herein, system 102 may share resources among television 104, soundbar and/or AVR 106, speakers 108 and 110, cable box 112, streaming box 114, game console 116, disc player 118, smartphone 120, and/or other media devices. Various implementations directed to system 102 enhancing user experience in association with media environment 100 are described in more detail herein.

In various implementations, system 102 and other media devices of media environment 100 such as television 104 shown may communicate with user 122 via smartphone 120. Alternatively, in various implementations, system 102 and media devices of media environment 100 may communicate with user 124 by voice utilizing input/output devices such as speakers 108 and 110 and/or with a microphone (not shown). In various implementations, smartphone 120 may also be a remote-control device such as one provided by the manufacture of television 104.

In various implementations, communication among components of media environment 100 may be established via a local network. For example, the local network may be a Wi-Fi network, a Bluetooth network, near-field communication (NFC) network, a wired network, etc., or any combination thereof. In some implementations, the local network may connect to the Internet.

In other implementations, media environment 100 may not have all of the components shown and/or may have other elements including other types of elements instead of, or in addition to, those shown herein. In the various implementations described herein, a processor of system 102 may cause the elements described herein (e.g., settings, commands, messages, user preferences, etc.) to be displayed in a user interface on one or more display screens. Such display screen may include, for example the display screen of television 104.

For ease of illustration, FIG. 1 shows one block for each of system 102, television 104, soundbar and/or AVR 106, speakers 108 and 110, cable box 112, streaming box 114, game console 116, disc player 118, smartphone 120. Each of these blocks may represent multiple like components. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

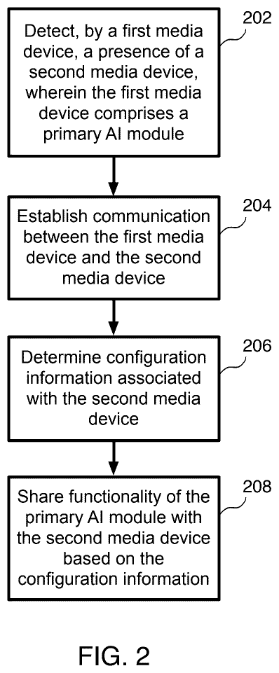

FIG. 2 is an example flow diagram for linking devices to enhance user experience, according to some implementations. Referring to both FIGS. 1 and 2, a method is initiated at block 202, where a system such as system 102 detects, via a first media device, the presence of a second media device. As described in more detail herein, the first media device includes a primary AI module.

In various implementations, the first media device is television 104, and the second media device may be any one or more of soundbar 106, speakers 108 and 110, cable box 112, streaming box 114, game console 116, disc player 118, smartphone 120, and/or other media devices in media environment 100. In some implementations, the first media device is smart phone 120, and the second media device may be any one or more of television 104, soundbar 106, speakers 108 and 110, cable box 112, streaming box 114, game console 116, disc player 118, and/or other media devices in media environment 100.

At block 204, system 102 establishes communication between the first media device and the second media device. As indicated above, in various implementations, communication among components of media environment 100 may be established via a local network. For example, the local network may be a Wi-Fi network, a Bluetooth network, near-field communication (NFC) network, a wired network, etc. The local network may also be an ultra-wideband (UWB), a ZigBee network, and may utilize technologies such as radio-frequency identification (RFID) technologies and quick-response (QR) code) technologies, or any combination thereof. In some implementations, the local network may connect to the Internet. Such networking may be implemented in a home, business (e.g., work), or in connection with a mobile network.

At block 206, system 102 determines configuration information associated with the second media device. Example implementations directed to various types of configuration information associated with the second media device are describe in more detail herein.

At block 208, system 102 shares functionality of the primary AI module with the second media device based on the configuration information. In various implementations, the primary AI module may involve large language models (LLMs), machine learning, and may be audio capable, video capable, and location capable.

In various implementations, the configuration information includes function information associated with the second media device. In various implementations, the function information may be associated with audio and/or video functions. Some media devices such as a television may have both audio and video functions. Some media devices such as a sound system television may be limited to audio functions. In various implementations, system 102 determines if a given second media device is an audio centric system, a video centric system, or both.

In various implementations, the system 102 accesses one or more functions of the second media device. The system 102 enhances the one or more functions of the second media device using the primary AI module of the first media device. For example, in various scenarios, different devices may have different types of intelligence built in, where the intelligence is geared to solve specific issues of given devices. As such, system 102 links multiple intelligent devices together to create a better overall user experience. For example, system 102 facilitates collaboration among linked smart devices to pool resources and capabilities. This enhances the user experience by combining different types of intelligence, such as audio, visual, and location-based capabilities.

System 102 enables multiple intelligent devices to link together and share resources to create a better user experience. For example, if one media device with AI has intelligence in audio capabilities or functions and another media device with AI has intelligence in visual capabilities or functions, system 102 may link these intelligent devices together to share their AI capabilities. This produces a better AV experience for the user.

System 102 also enables non-intelligent devices to link to intelligent devices to create a better user experience. For example, if a given device does not have any AI built in, system 102 may link the non-intelligent device to an intelligent device. By linking the two devices, the non-intelligent device may access and utilize the smart capabilities of the intelligent device. In various implementations, system 102 enables non-smart or non-intelligent devices to connect to smart or intelligent devices within the network. This thereby grants the non-intelligent devices access to advanced features and functionalities of the intelligent devices. This effectively upgrades the capabilities of the non-intelligent devices. System 102 may also link a non-intelligent device to a network of one or more intelligent devices to again create a better user experience.

While various implementations are described in the context of media devices in a media environment such as media environment 100 of FIG. 1, these implementations and others may apply outside of a media environment (e.g., outside of a home entertainment environment). For example, in various implementations, system 102 also enables devices to establish new links when in a mobile environment. When devices are mobile (e.g., away from a home, etc.), system 102 may establish new links between the devices to enable the devices leverage each other's capabilities (e.g., dynamic linking, AI resources, I/O ports, internet access, etc.). In various implementation, all linked local devices are capable of linking to cloud-based AI for further assistance/intelligence.

In various implementations, the configuration information includes input/output port information associated with the second media device. The input/output port information may include the types of input/output ports on a given media device. For example, the types of input/output ports may include high-definition multimedia interface (HDMI) ports, coaxial ports, audio-video receiver (AVR) ports, universal serial bus (USB) ports, fiber optic ports, etc. The particular types of ports on a given media device may vary, and will depend on the implementation. The input/output port information may also include the number of each type of port on a given media device. The particular number of ports on a given media device may vary, and will depend on the implementation.

In various implementations, system 102 accesses one or more input/output ports of the second media device. In various implementations, system 102 may access the one or more input/output ports via the central processing unit (CPU) and/or AI module of the given media device. When system 102 accesses the one or more input/output ports, system 102 determines the types of input/output ports, the number of each type of input/output port, which input/output ports are already occupied, and which input/output ports are free/available be plugged-in and linked to another media device. For example, system 102 may determine that television 102 has an HDMI port number 1 taken and an HDMI port number 2 available, etc.

The system 102 enhances operability of the one or more input/output ports of the second media device using the primary AI module of the first media device. In various implementations, system 102 determines optimal connections between two devices. System 102 may determine if a give device has a requirement to be connected to a particular type of port. For example, a given media device may have only a USB for connection. As such, that particular device if connected to a television would require that the television have a USB port. If a given device does not have the required type of port, system 102 may recommended a converter in order to enable a link or connection between the two devices. In some implementations, where both devices have wireless connection capabilities, system 102 may recommend a wireless connection if the appropriate wired connection is not possible for some reason.

In some implementations, if a given device can connect to another device using different optional types of ports and there is a preferred or optimal type of port, system 102 may recommend the appropriate optimal port. In some scenarios, an optimal port may be already connected to another device. If this is the case, and if that other device can be simply moved to another port without significant consequences, system 102 may recommend swapping ports for the other device and plugging the new device into the optimal port. This may be especially appropriate if the two devices are not used at the same time.

In various implementations, the configuration information includes setup information associated with the second media device. The setup information includes instruction for setting up the second media device as well as options for various setting parameters.

In various implementations, the system 102 accesses the configuration information associated with the second media device. As indicated above, in various implementations, system 102 along with its primary AI module resides in and is integrated with television 104. In various scenarios, the second media device may be one of the other media devices shown in FIG. 1 (e.g., soundbar and/or AVR 106, speakers 108 and 110, cable box 112, streaming box 114, game console 116, disc player 118, smartphone 120) or another media device (not shown) that is added at a future time. In various implementations, the system may access configuration information associated with the second media device, where the configuration information includes setup information. System 102 may access the configuration information directly from the second media device when the second media device is turned on and/or from the cloud (e.g., from a cloud server associated with the manufacture of the second media device, etc.).

As indicated above, the system along with its primary AI module may reside outside of television 102. For example, the system may reside in a smartphone such as smartphone 120 or in the cloud. In some scenarios, television 102 or the like may be considered the second media device. As such, in various implementations, the system may access configuration information associated with television 102, where the configuration information includes setup information. The system may access the configuration information directly from television 102 when television 102 is turned on and/or access the configuration information from the cloud (e.g., from a cloud server associated with the manufacture of television 102, etc.).

In various implementations, when the system and primary AI module reside in a device that already has access to the internet, such as smartphone 102, the second media device(s) need not be connected to the internet to be set up. For example, smartphone 102 may connect to the internet and to a second media device (e.g., television 102, etc.). By sharing resources, the second media device may connect to the internet via smartphone 102 or other device where the system and primary AI module reside.

The system 102 configures the second media device using the primary AI module of the first media device. Once system 102 has obtained the configuration information, system 102 may proceed to setup and configure the second media device using the AI module.

While various implementations are described herein in the context of input/output ports, these implementations and others also apply to other hardware resources of different media devices. For example, the primary AI module of system 102 may access various sensors of different devices. The sensors may include cameras. In some implementations, if a device to be connected has an associated quick-response (QR) code, system 102 may enable the user to scan the QR code using a camera or smartphone. If a device to be connected has a radio-frequency identification (RFID) attached to it, the system 102 may automatically detect the RFID tag attached to the device. System 102 may then access any information associated with the QR code or RFID tag. The system may determine information about the device to be connected (e.g., manufacture, model, connection requirements, resources such as AI modules, input/output ports, sensors, etc.). System 102 may cause any such available information including set up instructions on television 104 and/or smartphone 120.

In some implementations, system 102 may recommend particular media items for the user to consume. For example, if a given media device is presenting a media item such as a song or album that is in one format (e.g., MP3, etc.), and a higher-quality format is available and might be preferred, system 102 may recommend a different format (e.g., streaming version, etc.), which may have a higher quality, thereby improving the user experience.

In some implementations, system 102 may recommend particular media devices to be added to the user's current media environment. For example, if the user is shopping for a particular type of media device such as a Blu-ray player, system 102 may recommend options for the user to purchase. Such recommended device may include devices that are compatible and/or optimal for the user's current media environment, thereby improving the user experience.

Implementations described herein provide various benefits. For example, implementations enhance user experience by linking electronic devices and sharing resources among the devices. Implementations enable devices to share AI resources, functionality, and components such as I/O ports, sensors, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

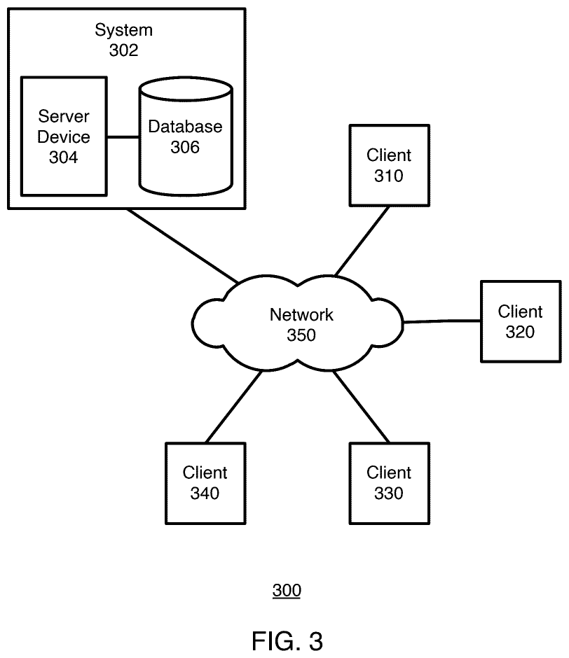

FIG. 3 illustrates a block diagram of an example network environment 300, which may be used for some implementations described herein. In some implementations, network environment 300 includes a system 302, which includes a server device 304 and a network database 306. For example, system 302 may be used to implement system 102 of FIG. 1, as well as to perform implementations described herein. Network environment 300 also includes client devices 310, 320, 330, and 340, which may communicate with each other directly or via system 302. Client devices 310, 320, 330, and 340 may be televisions, as well as other media devices such as soundbars, speakers, cable boxes, streaming boxes, game consoles, disc players, smartphones, etc. Network environment 300 also includes a network 350 through which system 302 and client devices 310, 320, 330, and 340 communicate. Network 350 may be any suitable communication network such as a Wi-Fi network, Bluetooth network, the Internet, etc.

For ease of illustration, FIG. 3 shows one block for each of system 302, server device 304, and network database 306, and shows four blocks for client devices 310, 320, 330, and 340. Blocks 302, 304, and 306 may represent multiple systems, server devices, and network databases. Also, there may be any number of client devices. In other implementations, network environment 300 may not have all of the components shown and/or may have other elements including other types of elements instead of, or in addition to, those shown herein.

While server device 304 of system 302 performs implementations described herein, in other implementations, any suitable component or combination of components associated with system 302 or any suitable processor or processors associated with system 302 may facilitate performing the implementations described herein.

In the various implementations described herein, a processor of system 302 and/or a processor of any client device 310, 320, 330, and 340 causes the elements described herein (e.g., information, etc.) to be displayed in a user interface on one or more display screens.

Implementations may apply to any network system and/or may apply locally for an individual user. For example, implementations described herein may be implemented by system 102 and/or any client device 310, 320, 330, and 340. System 302 may perform the implementations described herein on a stand-alone computer, tablet computer, smartphone, etc. System 302 and/or any of client devices 310, 320, 330, and 340 may perform implementations described herein individually or in combination with other devices.

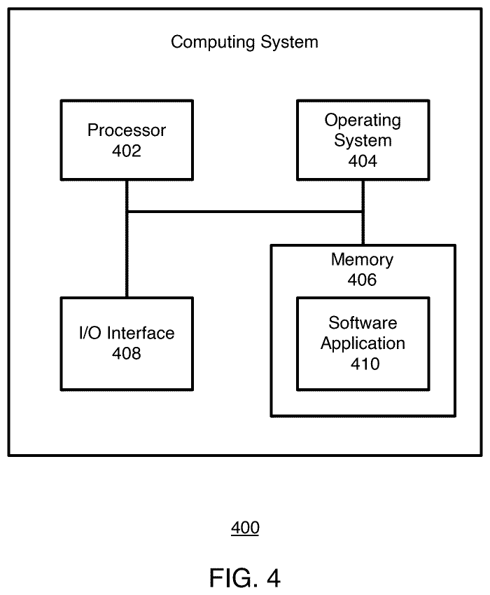

FIG. 4 illustrates a block diagram of an example computing system 400, which may be used for some implementations described herein. For example, computing system 400 may be used to implement system 102 of FIG. 1 and/or server device 304 of FIG. 3, as well as to perform implementations described herein. In some implementations, computing system 400 may include a processor 402, an operating system 404, a memory 406, and an input/output (I/O) interface 408. In various implementations, processor 402 may be used to implement various functions and features described herein, as well as to perform the method implementations described herein. While processor 402 is described as performing implementations described herein, any suitable component or combination of components of computing system 400 or any suitable processor or processors associated with computing system 400 or any suitable system may perform the steps described. Implementations described herein may be carried out on a user device, on a server, or a combination of both.

Computing system 400 also includes a software application 410, which may be stored on memory 406 or on any other suitable storage location or computer-readable medium. Software application 410 provides instructions that enable processor 402 to perform the implementations described herein and other functions. Software application may also include an engine such as a network engine for performing various functions associated with one or more networks and network communications. The components of computing system 400 may be implemented by one or more processors or any combination of hardware devices, as well as any combination of hardware, software, firmware, etc.

For ease of illustration, FIG. 4 shows one block for each of processor 402, operating system 404, memory 406, I/O interface 408, and software application 410. These blocks 402, 404, 406, 408, and 410 may represent multiple processors, operating systems, memories, I/O interfaces, and software applications. In various implementations, computing system 400 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to perform operations comprising:
detecting, by a first media device, a presence of a second media device, wherein the first media device comprises a primary artificial intelligence (AI) module;
establishing communication between the first media device and the second media device;
determining configuration information associated with the second media device; and
sharing functionality of the primary AI module with the second media device based on the configuration information.

2. The system of claim 1, wherein the configuration information comprises function information associated with the second media device.

3. The system of claim 1, wherein the logic when executed is further operable to cause the one or more processors to perform operations comprising:
accessing one or more functions of the second media device; and
enhancing the one or more functions of the second media device using the primary AI module of the first media device.

4. The system of claim 1, wherein the configuration information comprises input/output port information associated with the second media device.

5. The system of claim 1, wherein the logic when executed is further operable to cause the one or more processors to perform operations comprising:
accessing one or more input/output ports of the second media device; and
enhancing operability of the one or more input/output ports of the second media device using the primary AI module of the first media device.

6. The system of claim 1, wherein the configuration information comprises setup information associated with the second media device.

7. The system of claim 1, wherein the logic when executed is further operable to cause the one or more processors to perform operations comprising:
accessing the configuration information associated with the second media device; and
configuring the second media device using the primary AI module of the first media device.

8. A non-transitory computer-readable storage medium with program instructions stored thereon, the program instructions when executed by one or more processors are operable to cause the one or more processors to perform operations comprising:
detecting, by a first media device, a presence of a second media device, wherein the first media device comprises a primary artificial intelligence (AI) module;
establishing communication between the first media device and the second media device;
determining configuration information associated with the second media device; and
sharing functionality of the primary AI module with the second media device based on the configuration information.

9. The computer-readable storage medium of claim 8, wherein the configuration information comprises function information associated with the second media device.

10. The computer-readable storage medium of claim 8, wherein the instructions when executed are further operable to cause the one or more processors to perform operations comprising:
accessing one or more functions of the second media device; and
enhancing the one or more functions of the second media device using the primary AI module of the first media device.

11. The computer-readable storage medium of claim 8, wherein the configuration information comprises input/output port information associated with the second media device.

12. The computer-readable storage medium of claim 8, wherein the instructions when executed are further operable to cause the one or more processors to perform operations comprising:
accessing one or more input/output ports of the second media device; and
enhancing operability of the one or more input/output ports of the second media device using the primary AI module of the first media device.

13. The computer-readable storage medium of claim 8, wherein the configuration information comprises setup information associated with the second media device.

14. The computer-readable storage medium of claim 8, wherein the instructions when executed are further operable to cause the one or more processors to perform operations comprising:
accessing the configuration information associated with the second media device; and
configuring the second media device using the primary AI module of the first media device.

15. A computer-implemented method comprising:
detecting, by a first media device, a presence of a second media device, wherein the first media device comprises a primary artificial intelligence (AI) module;
establishing communication between the first media device and the second media device;
determining configuration information associated with the second media device; and
sharing functionality of the primary AI module with the second media device based on the configuration information.

16. The method of claim 15, wherein the configuration information comprises function information associated with the second media device.

17. The method of claim 15, further comprising:
accessing one or more functions of the second media device; and
enhancing the one or more functions of the second media device using the primary AI module of the first media device.

18. The method of claim 15, wherein the configuration information comprises input/output port information associated with the second media device.

19. The method of claim 15, further comprising:
accessing one or more input/output ports of the second media device; and
enhancing operability of the one or more input/output ports of the second media device using the primary AI module of the first media device.

20. The method of claim 15, wherein the configuration information comprises setup information associated with the second media device.
